(19) United States
(12) Patent Application Publication
(10) Pub. No.: US 2026/0138815 A1
(43) Pub. Date: May 21, 2026

(54) CELLULOSIC MATERIAL CAPSULE FOR THE PREPARATION OF SOLUBLE EDIBLE PRODUCTS AND PROCESS FOR ITS PRODUCTION

(71) Applicant: WEADD, LDA, MARINHA GRANDE (PT)

(72) Inventors: Agostinho Miguel Quitério Garcia Carvalho, Leiria (PT); Daniel Freire Falcão Teles Caramelo, Lisboa (PT); Sónia Raquel Da Silva Gomes Josué, Leiria (PT)

(21) Appl. No.: 19/394,019

(22) Filed: Nov. 19, 2025

(30) Foreign Application Priority Data
Nov. 19, 2024 (PT) 119847

(51) Int. Cl. B65D 85/804; A23F 3/18; A23F 5/26

(52) U.S. Cl. CPC B65D 85/8049; A23F 3/18; A23F 5/26

(57) ABSTRACT

A capsule of cellulosic material for a soluble edible product, the capsule comprising a container delimited by a side wall, a water inlet cover member and an edible product outlet cover member. The water inlet cover member can include at least one double-blind groove arranged on an inner surface thereof. The double-blind groove including a first blind groove and a second blind groove. The second blind groove is contained within the first blind groove. The depth of the first blind groove is lower than a depth of the second blind groove. A process of producing the capsules and is relevant to the industry of producing soluble edible products.

### FIELD OF THE INVENTION

The present invention relates to single-use capsules made of cellulose material for the preparation of soluble edible products, such as espresso coffee, tea or other soluble beverages, and to the manufacturing process thereof. The invention falls within the food industry, more specifically in the industry of producing soluble edible products.

### BACKGROUND OF THE INVENTION

The state of the art includes various solutions relating to single-use capsules for the preparation of edible products, such as espresso coffee, tea and other soluble products.

Capsules are small containers that hold the edible product, used in compatible machines, allowing for the rapid preparation of the edible product. Generally, a capsule comprises two members: a base cup and a lid. The base cup has a bottom that is either completely closed or pre-perforated, in either case perforated by the punches of the edible product machine where the capsule is placed. The mouth of the capsule cup may have a peripheral flap that then serves as a surface for attaching the lid, which usually consists of a plastic lid, aluminium foil, filter paper, or micro-perforated plastic.

The capsules used in edible product vending machines, after being placed in the machine, are perforated on both sides by a mechanized punching system, wherein some are perforated when the lid of the machine compartment where the capsule is placed is closed, while others are perforated by a punching mechanism incorporated into the machine and powered by an electrical system that ensures the pumping and heating of water.

There are also capsule coffee machines that work with the aid of a lever that opens an extraction unit consisting of a container where the capsule is housed after being inserted into the machine and a sealing lid that breaks or opens the capsule and introduces hot water. Once full and under high pressure, the capsule opens and releases the water mixture, which passes through the edible substance to the outside of the machine. Finally, the capsule is ejected by repeating the opening movement of the lever.

In the current state of the art, there are various types of capsules made from numerous shapes and materials (paper, plastic, and metal—aluminium), resulting in different compositions that influence their performance in preserving the edible product. The use of various materials in capsule production, besides increasing production costs, creates problems with the collection, separation, and sorting of waste products, especially when capsules are collected for recycling, which is why it is sometimes more common to dispose of it in regular trash. Many currently available capsules are not recyclable or are difficult to recycle. Currently, aluminium is considered the best material for capsule production, as it ensures more effective preservation of the properties of edible products and also has the advantage of being “infinitely recyclable”, quickly entering a new production cycle, and being a very lightweight material. However, this material has very different rigidity and resistance characteristics than plastic, which may lead to some disadvantages in terms of plastic deformation when applied to the part of the lid that is opened by the machine.

Currently available coffee capsules have accustomed consumers to enjoying coffee quickly, hygienically, and with high quality. However, the material used to make the capsule plastic or metal-combined with the organic matter of the coffee inside, make their recycling process very complex and difficult to implement. One of the main concerns of coffee brands today is the development and presentation of solutions that reduce the ecological footprint caused by capsule consumption.

There are coffee capsules on the market that are very difficult to recycle, both because they use two combined materials—plastic and aluminium—and because the way the lid and container are welded together makes access to the organic matter inside virtually impossible. Currently, there are some state-of-the-art solutions that address a more eco-responsible and sustainable approach, using recyclable materials and limiting the amount of material used in capsule manufacturing.

Another difficulty that currently exists with edible product capsules is the fact that they present a very demanding mechanical performance for coffee machines, since their opening depends on the rupture of a plastic “door” at one end of the cylinder through the application of a force that, over its continued use, damages the sealing behaviour required by the machine's extraction groups.

Document PT 109815B discloses a capsule with a configuration that optimizes the positioning and perforation of the capsule through its circular lid-type construction member, which is adapted to provide a flow passage into the interior of the container-type construction member. The passage has a weakened material region that is adapted so that it ruptures under a certain flow pressure. It also mentions the existence of a projection member that exerts a lever-type mechanical force on the weakened material region. In this case, the circular lid-type construction member that undergoes perforation is made of plastic material.

In turn, document PT 107043B presents a capsule comprising a part of the lid that may have at least one facilitated rupture formation for the entry of water. The lid has at least one facilitated rupture formation for the entry of infusion water into the container. The container, lid, base, and perforating member are made of plastic, while the protective member is an aluminium plate. The perforation of the capsule lid is not mechanical, but only of the hydraulic type.

Lastly, document PT 2139791 discloses a single-use retention capsule for an aromatic essence to produce an infusion, comprising a container with a cover and a perforated base externally covered with a protective member, and a perforating member present on the inner face of said protective member, which acts by the pressure of the fluid created inside the capsule container, allowing the infusion to flow out. The flat cover has at least one groove to facilitate the infusion water into the container. It is also stated that the container, cover, base, and perforating member are made of plastic, with only the protective member being an aluminium plate. In this case, the perforation of the cover is of the hydraulic type.

The solutions disclosed in the state of the art are mainly aimed at optimizing capsules to achieve a more efficient and precise opening by the machine, since an incorrect opening can negatively influence the achievement of an ideal infusion, as well as cause the release of materials that contaminate the infusion, and the unwanted release of edible product from the capsule.

However, none of the state-of-the-art solutions address the problem of capsules exhibiting very demanding mechanical performance for coffee machines, which, over time, damages the required sealing behaviour of the machine's extraction groups.

On the other hand, a more recent and growing use of capsules made from cellulose-based material, generically referred to as paper capsules, which are produced from paper pulp, has introduced new problems associated with their perforation by the machine in order to introduce water under pressure for the subsequent infusion and distribution of the beverage.

Given the physical and mechanical nature of the material used in capsules made from paper pulp, the behaviour of this material when subjected to machine perforation is different from that observed in plastic or aluminium capsules.

In fact, the cellulosic material of the paper capsules tends to be pushed by the punching members of the machine's mechanical perforation unit but, in many cases, it is not actually perforated, which prevents the normal functioning of the beverage preparation and dispensing system.

Therefore, while paper capsules can reduce the load applied to the punching units of the machines, they also introduce a functional problem of lack of perforation that does not occur with more conventional plastic or aluminium capsules.

There is thus a need in the technology for improved capsules, made of cellulosic material, for machines dispensing soluble edible products, with characteristics that allow for correct and effective rupture and passage of water, and consequent extraction of edible product under optimal and organoleptically suitable conditions.

### BRIEF DESCRIPTION OF THE DRAWINGS

The following is a detailed description of the invention, with reference to the accompanying drawings, in which:

FIG. 1 schematically shows a partially cutaway view of one embodiment of the capsule (1) of the invention, as well as a corresponding enlarged view (A) of a detail of the water inlet cover member (22) having a double-blind groove (4) on its inner surface (31).

FIG. 2 shows schematically a partially cutaway view of an alternative embodiment of the capsule (1) of FIG. 1, wherein the inner surface of its water inlet cover member (22) is coated with a microfilm (5).

FIG. 3 shows an isolated enlarged detail view of the capsule in FIG. 1, in which the water inlet cover member is visible, equipped with a double-blind groove on its inner surface, the depths (411, 421) of their first and second grooves, respectively, being equally visible, as well as the presence of a punch member (6) from an edible product machine, before the perforating action was triggered.

FIG. 4 shows an enlarged view of the capsule from FIG. 3 after the perforating action has occurred.

FIG. 5 shows a schematic cross-sectional view of the interior of a capsule of the invention (without soluble edible product) and an enlarged detail thereof of the area of the water inlet cover member (22), in which a double-blind groove (4) is clearly visible on the inner surface (31) of the water inlet cover member (22) and respective first and second grooves (41, 42).

FIG. 6 schematically represents the capsule of FIG. 5 after it has been perforated by punch members (6) of an edible product machine.

FIG. 7 schematically presents, in a plan view, a most preferred embodiment of the capsule (1) of the invention with the presence of a double-blind groove (4), circularly closed, arranged on the inner surface of the water inlet cover member.

FIG. 8 schematically presents, in a plan view, an alternative embodiment of the capsule (1) of the invention with the presence of a double-blind groove (4), circularly interrupted/open, arranged on the inner surface of the water inlet cover member.

FIG. 9 schematically represents, in a plan view, another embodiment of the capsule (1) of the invention, on whose inner surface of the water inlet cover member there are arranged two double-blind grooves (4) configuring two semicircles.

FIG. 10 schematically represents, in a plan view, yet another embodiment of the capsule (1) of the invention, on whose inner surface of the water inlet cover member there are arranged three double-blind grooves (4).

FIG. 11 schematically illustrates, in a plan view, yet another embodiment of the capsule (1) of the invention, compatible with machines that have perforation systems with a punching member that acts on the central part of the outer surface of the water inlet cover member of the capsule, in which case the double-blind groove (4) is located in the central part of the inner surface of the water inlet cover member.

FIG. 12 schematically illustrates, in a plan view, a capsule identical to that in FIG. 11, wherein two double-blind grooves (4) are arranged, in a cross configuration, in the central part of the inner surface of the water inlet cover member.

### SUMMARY OF THE INVENTION

The present invention relates to a capsule (1) of cellulosic material for a soluble edible product, the capsule (1) comprising a closed container (2), which contains a hollow interior (24) containing an individual dose of a soluble edible product, and the container (2) being delimited by a side wall (21), a water inlet cover member (22) and an edible product outlet cover member (23), wherein the water inlet cover member (22) comprises an inner surface (31), facing the interior (24) of the container (2), an outer surface (32) opposite to said inner surface (31) and a thickness (3), defined by the distance between the inner surface (31) and the outer surface (32); wherein said water inlet cover member (22) further comprises at least one double-blind groove (4) arranged on its inner surface (31), wherein the double-blind groove (4) consists of a first blind groove (41) and a second blind groove (42); and wherein the second blind groove (42) is contained within the first blind groove (41) and a depth (411) of the first blind groove (41) is lower than a depth (421) of the second blind groove (42).

In a preferred embodiment, the double-blind groove (4) is arranged in a closed circumferential configuration on the inner surface (31) of the water inlet cover member (22).

In an alternative embodiment, the double-blind groove (4) is arranged in an open circumferential configuration on the inner surface (31) of the water inlet cover member (22).

In another embodiment, the capsule of the invention comprises two double-blind grooves (4), configuring two semicircles, arranged in a same circumferential line on the inner surface (31) of the water inlet cover member (22).

In yet another embodiment, the capsule comprises three double-blind grooves (4) arranged in a same circumferential line on the inner surface (31) of the water inlet cover member (22).

In a particular aspect, in embodiments comprising an interrupted double-blind groove (4) or two or more double-blind grooves (4) arranged in a same circumferential line on the inner surface (31) of the water inlet cover member (22), the capsule further comprises one or more single grooves (42′) arranged in the same said circumferential line and connected to the second grooves (42) of the double grooves (4).

In an optional embodiment, the capsule (1) comprises a double-blind groove (4) arranged in a central part of the inner surface (31) of the water inlet cover member (22).

In another optional embodiment, the capsule (1) comprises two double-blind grooves (4) arranged, in cross configuration, in a central part of the inner surface (31) of the water inlet cover member (22).

In a preferred aspect, the said side wall (21), the water inlet cover member (22) and the edible product outlet cover member (23) of the capsule (1) define an inner surface (7) of the container (2), the inner surface (7) of the container being partially or totally coated with a microfilm (5), wherein the microfilm (5) is selected from the group consisting of poly(lactic acid) (PLA), polyhydroxybutyrate (PHB) and polyhydroxybutyrate-co-polyhydroxyhexanoate (PHBHx).

Most preferably, the cellulosic material of the capsule (1) is paper pulp.

In an alternative embodiment, the capsule of the invention further comprises at least one double-blind groove (4) arranged on an inner surface of the edible product outlet cover member (23).

The invention also relates to a process for producing a capsule (1) of cellulosic material, the process comprising the step of forming at least one double groove (4) on an inner surface (31) of the water inlet cover member (22) of the capsule (1).

The capsule (1) of the invention is intended to be used in the preparation of espresso coffee, tea or other soluble edible products.

### DETAILED DESCRIPTION OF THE INVENTION

The present invention relates to single-use capsules made of cellulose material for preparing soluble edible products, such as espresso coffee, tea, or similar products. The invention also relates to the process for producing said capsules.

Edible product capsules, such as coffee capsules, have the advantage of allowing consumers to consume the edible beverage quickly, hygienically, and with high organoleptic quality. However, the materials, plastic or aluminium, that make up the most conventional capsules, combined with the organic matter of the edible product inside, make their recycling process very complex and difficult to implement. Therefore, the industry has focused on developing alternative solutions that reduce the ecological footprint caused by capsule consumption. In this sense, the present invention also addresses capsules made from more sustainable materials.

Thus, the capsule (1) of the present invention is produced from cellulosic material, which is compostable, namely from a cellulose pulp, for example paper pulp, which may optionally be laminated with a microfilm of a biopolymer. After use, these materials are suitable for disposal in unsorted waste or organic waste. The most common cellulosic materials that may be applied to the capsule (1) of the present invention are selected from the group comprising paper, cardboard, paperboard and their mixtures.

The invention will be described below with reference to the accompanying figures, which represent merely illustrative and exemplary embodiments of the capsule of the invention.

The capsule (1) of the present invention is designed for use in machines dispensing soluble edible products, such as espresso coffee, tea or other soluble products, wherein the opening of the capsule is made by direct action of punching members of said machines on the water inlet cover member (22) of the capsule (1), this cover member (22) being typically located at one end of the container (2) of the capsule (1).

That is, in practice, regardless of the descriptive orientation of the capsule (1), in practice, the user can only insert the capsule into a compatible beverage machine in a single, suitable orientation, which is provided for in the design of the machine and the compatible capsules, so that the water inlet cover member (22) of the capsule (1) is positioned in a suitable position for the machine to pierce it.

The aim of the present invention is to provide a single-use capsule made of cellulosic material, improved in its design, for espresso, tea or other soluble coffee machines, which is adaptable to any compatible machine on the market and configured in such a way that its opening for water entry results from a first perforation action exerted by the machine on its water inlet cover member (22), guaranteeing effective penetration of the machine's punching members (6) into the interior (24) of the capsule container (2).

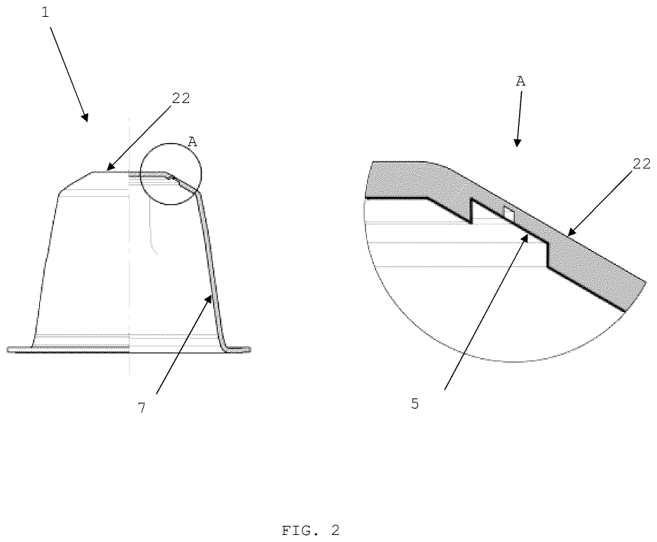

With reference to FIG. 2, in one embodiment of the invention, there is a microfilm (5) present on the water inlet cover member (22), the breaking of which is also necessary to allow the punching members (6) of the machine to access the interior (24) of the capsule container (2) and, consequently, enable the extraction of edible product.

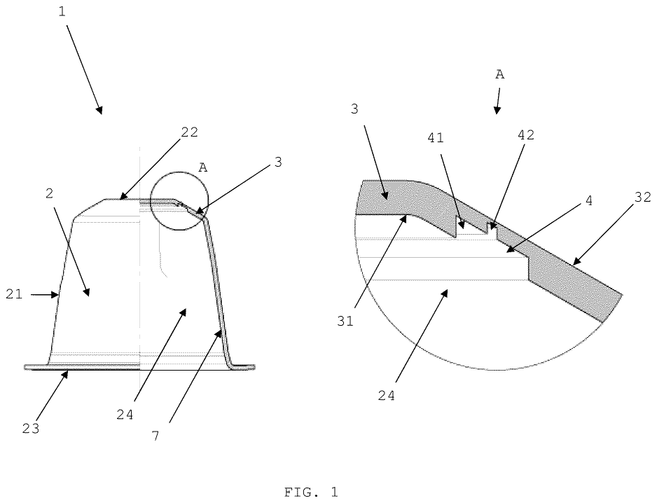

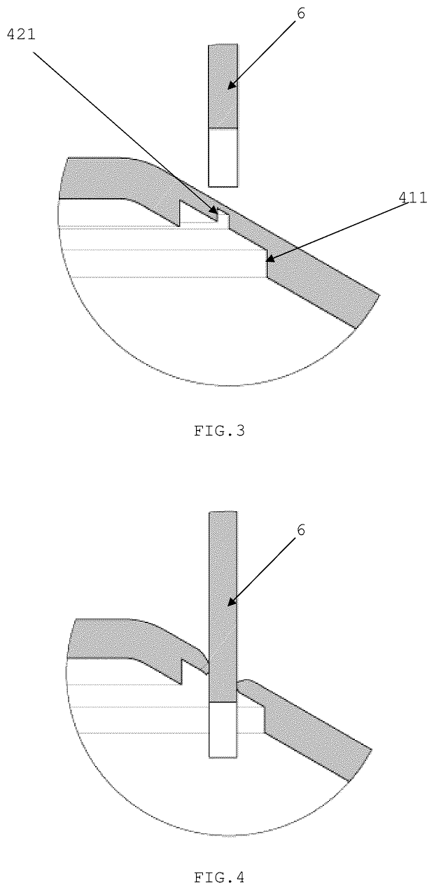

Referring to FIGS. 1 and 3, the present invention provides a capsule (1) of cellulosic material for a soluble edible product, the capsule (1) comprising a closed container (2), which contains a hollow interior (24) containing an individual dose (not shown) of a soluble edible product, and the container (2) being delimited by a side wall (21), a water inlet cover member (22) and an edible product outlet cover member (23), wherein the water inlet cover member (22) comprises:
an inner surface (31), facing the interior (24) of the container (2),
an outer surface (32), opposite to said inner surface (31) and
a thickness (3), defined by the distance between the inner surface (31) and the outer surface (32);
   and wherein
   said water inlet cover member (22) further comprises at least one double-blind groove (4) arranged on its inner surface (31), the double-blind groove (4) consisting of a first blind groove (41) and a second blind groove (42); the second blind groove (42) being contained within the first blind groove (41) and the depth (411) of the first blind groove (41) being lower than the depth (421) of the second blind groove (42).

In the context of the present description, the term “comprising” should be understood as “including, among others.” As such, the term should not be interpreted as “consisting only of.”

Within the scope of the present invention, the terms “water inlet cover member” and “edible product outlet cover member” should be understood as the members that close the side wall at its tops (lower and upper). These two cover members and the side wall thus define a hollow internal cavity of the container, which is indispensable to the container so that it can hold an individual dose of an edible product.

Within the scope of the present invention, “groove” means a notch made in the thickness of the water inlet cover member of a capsule.

Within the scope of the present invention, “double-groove” means the combination of two grooves, wherein a second groove is contained or arranged within the first groove; and the second groove has a greater depth or penetration (relative to the thickness of the material in which it is located) than the first groove.

The term “blind” in the context of the expression “blind groove” or “double-blind groove”, means that the groove or double-groove only partially penetrates the thickness of the capsule's water inlet cover member; that is, it does not correspond to a passage opening or slit that goes through the entire thickness of the material. The skilled in the art will know how to implement a groove or double-groove with the characteristics listed in this description on the inner surface of a capsule's water inlet cover member without needing additional information.

Note that any value X presented in the course of this description should be interpreted as an approximate value of the actual value X, since such an approximation to the actual value would be reasonably expected by a person skilled in the art due to experimental and/or measurement conditions that introduce deviations from the actual value. Thus, for example, reference to “0.7” means a value of “about 0.7”.

With reference to FIGS. 1 and 2, in the capsule of the present invention, said side wall (21), the water inlet cover member (22) and the edible product outlet cover member (23) define an inner surface (7) of the container (2). In an embodiment illustrated in FIG. 2, the inner surface (7) of the container (2) is coated with a microfilm (5).

The inner surface (7) of the container (2) may be partially or totally coated with a microfilm (5).

Said microfilm (5) has the function of creating a barrier between the soluble edible product contained within the capsule (1) and the air of the external environment, allowing the soluble edible product to be preserved, maintaining its quality and shelf life for more than 12 months.

The microfilm (5) comprises a film of a biopolymer whose thickness is in the range of 1-200 μm. The biopolymer can be selected from the group comprising poly(lactic acid) (PLA), polyhydroxybutyrate (PHB) and polyhydroxybutyrate-co-polyhydroxyhexanoate (PHBHx).

In one embodiment of the present invention, the joining of the side wall (21) with the water inlet cover member (22) is carried out by fitting and subsequently it is heat-welded or ultrasonically welded.

In any case, the skilled in the art may use any other method of joining the side wall (21) with the water inlet cover member (22).

Since the capsule (1) of the present invention is formed from a cellulosic material that constitutes its structural body, and since this structure is laminated internally with a microfilm (5) of a biopolymer, it is ensured that the edible product does not have any contact with the air/atmosphere outside the capsule, which constitutes an improvement with respect to the organoleptic conditions of the edible product compared to capsules that do not include this insulation, given that the cellulosic material is essentially a porous material.

However, it should be noted that the presence or absence of the aforementioned microfilm (5) does not affect other functional aspects of the capsule, namely its perforation by punch members (6) of an edible product machine.

On the other hand, the cellulosic material of the capsule (1), due to its physical and chemical nature and constitution, offers little resistance to mechanical deformation, which is undesirable for use in edible product systems (machines) that base their operation on the perforation (rupture) of a capsule wall by inserting punching members (6) of the machine. In fact, it is observed, in many cases, that the capsule material (1) deforms under the action of the punching members (6) without breaking, which prevents the subsequent entry of water into the interior (24) of the capsule container, thus compromising the function of distributing the edible product to the user.

In the attempt to solve this problem, the thickness (3) of the wall of the water inlet cover member (22) was locally reduced, with a view to weakening that part of the capsule in relation to the remaining structural parts of the capsule container (2). However, the desired effect was not achieved since, in many cases, the problem of mere deformation of the material without rupture persisted and the capsules were not perforated by the punching members (6) of the machine.

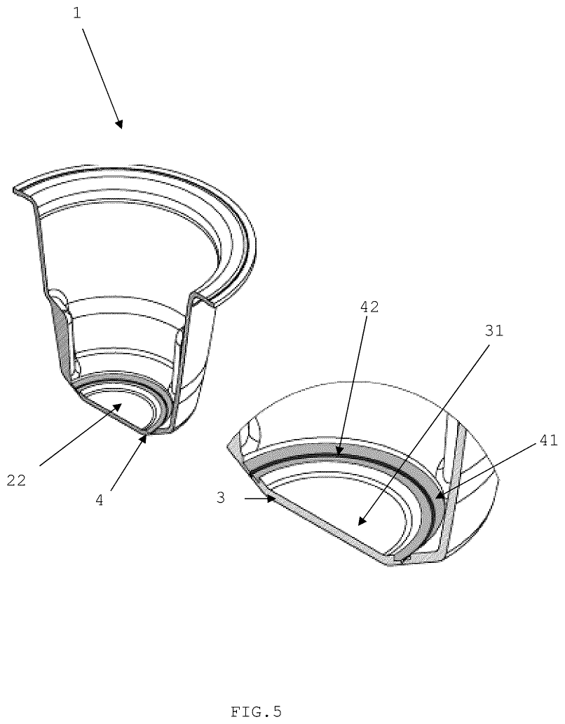

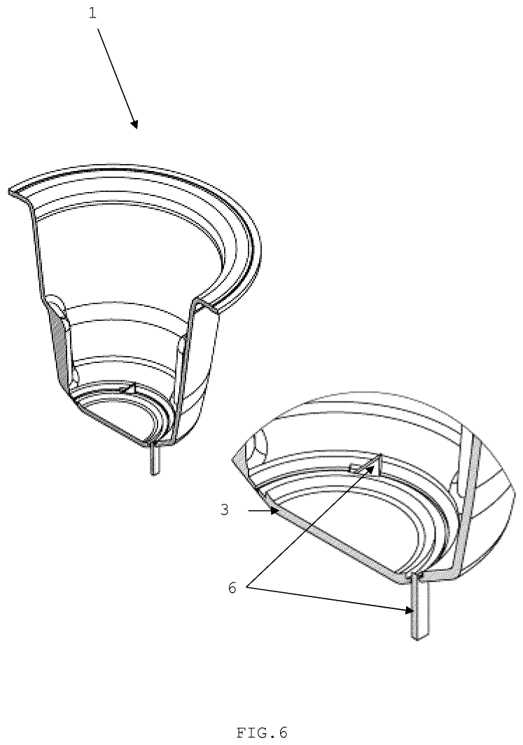

Surprisingly, it was only possible to solve the aforementioned problem of perforation of the water inlet cover member (22) of the capsule (1) by opening, or in other words, arranging, a double-blind groove (4) on the inner surface (31) of the water inlet cover member (22). The double-blind groove (4) consists of a first blind groove (41) and a second blind groove (42), the second blind groove (42) being contained within the first blind groove (41) and the depth (411) of the first blind groove (41) being lower than the depth (421) of the second blind groove (42), as illustrated in FIGS. 1, 3 and 4.

Several capsules with different width and depth ratios between the first blind groove (41) and the second blind groove (42) were successfully tested, whereby it was concluded that the decisive factor is the existence of a double-blind groove (4), wherein the second blind groove (42) is contained within the first blind groove (41), that is, the second groove (42) is located within the radial space of the first groove (41), and is therefore necessarily narrower than the first (41), and the second groove (42) is deeper than the first (41), that is, the second groove (42) ends closer to the outer surface (32) of the water inlet cover member (22) than the first groove (41), as clearly illustrated, for example, in FIGS. 1 and 3.

Without intending to theorize, it is thought that the double-blind groove configuration, as described above, provides a stress distribution, not anticipated in the prior art, which allows and facilitates the efficient penetration of the machine's punch members into the cellulosic material of the capsule.

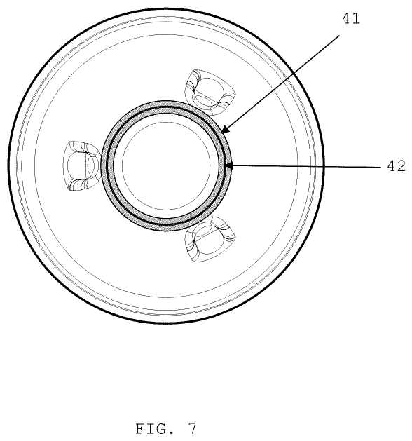

Referring to FIG. 7, in a most preferred embodiment of the capsule of the invention, the double-blind groove (4) is arranged, as a single member, in a closed circular configuration on the inner surface of the water inlet cover member.

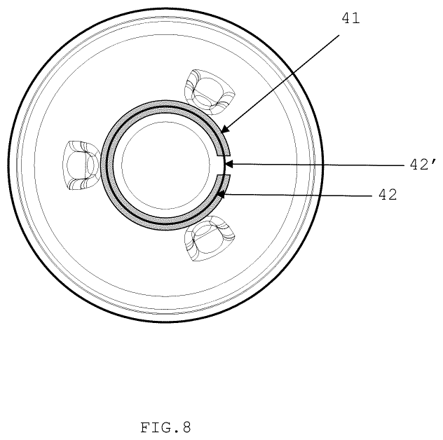

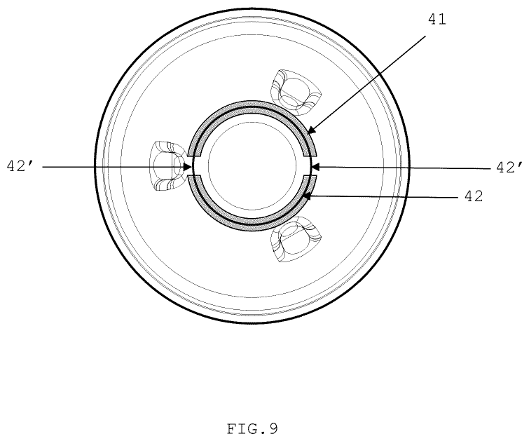

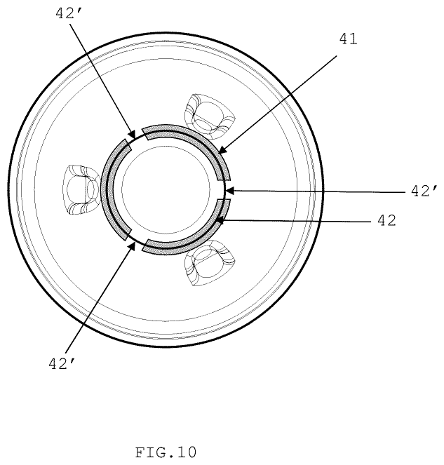

Other embodiments are represented in FIG. 8 to 10, in which the double-blind groove (4) is arranged on the inner surface of the water inlet cover member, respectively: in the form of an open circumferential double-blind groove (4); in the form of two double-blind grooves (4) configuring two semicircles; and in the form of three double-blind grooves (4) arranged in a circumferential line.

It should be noted that, in the three embodiments of FIG. 8 to 10, one or more simple grooves (42′) are arranged on the inner surface of the water inlet cover member, thus extending this or these grooves (42′) in a same circular line (which is imaginary and referred to for the purposes of better understanding), beyond the configuration of the double groove(s) (4), which constitutes a mere alternative to the configurations that are based only on double grooves (4).

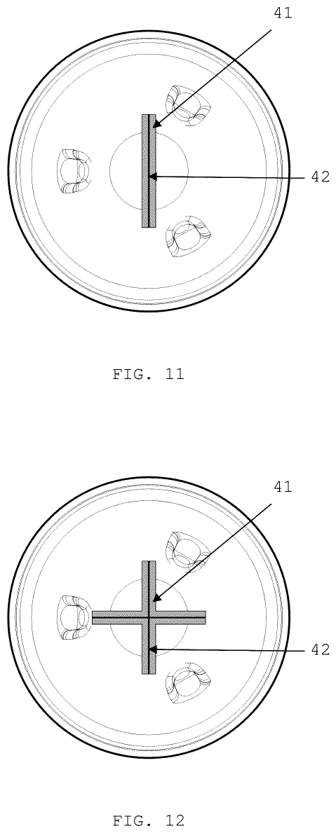

In FIGS. 11 and 12, other embodiments of capsules compatible with machines that have perforation systems with a punching member acting on the central part of the outer surface of the capsule's water inlet cover member can be observed. In the case of FIG. 11, a double-blind groove (4) is arranged in the central part of the inner surface of the water inlet cover member and, in the embodiment of FIG. 12, there are two double-blind grooves (4), arranged in a cross configuration, in the central part of said inner surface of the water inlet cover member.

Different numerical ratios between the widths of the first- and second-blind grooves (41, 42), as well as the ratios between their penetration depths into the material of the water inlet cover member (22), do not decisively affect the perforating action, which was successfully achieved in a wide range of dimensional ratios, according to tests carried out.

Normally, the thickness adopted in the art for manufacturing containers (2) of cellulosic material capsules is between 0.6 mm and 0.8 mm, most frequently 0.7 mm. Although different ratios between the depths (411, 421) for the grooves (41, 42) respectively were carried out, it was found that, from a production point of view, for capsules with thicknesses of 0.7 mm, a first groove depth (411) of 0.4 mm and a second groove depth (421) of 0.6 mm provided good perforating performance by the machine. These values are merely indicative and are not exclusive for good performance, however, it is found that a depth (421) greater than the aforementioned 0.6 mm is difficult to achieve without running the risk of incurring a total perforation of the thickness (3) of the water inlet cover member (22), which is undesirable. Also, for practical implementation reasons, as well as for reaching the functional threshold, differences of lower than 0.1 mm between the depth (411) and the depth (421) of the grooves constituting the double-blind groove (4) are not considered desirable.

As for the width of the grooves (41, 42) of the double groove (4), for practical implementation reasons, it may preferably be between 1 mm and 2 mm for the first groove (41) and between 0.5 mm and 1 mm for the second groove (42). However, other values may be used for the width of said grooves (41, 42) without prejudice to the functional aim they are intended for, provided that such implementations are consistent with the space available in the cover member and with the process/system for implementing said grooves in the production of the capsules.

Thus, it was found that, with the new configuration of the water inlet cover member (22) equipped with at least one double-blind groove (4), it is possible to ensure correct functional performance of extracting edible product from cellulosic capsules and, simultaneously, ensure mechanical action of piercing the capsule without requiring a very demanding mechanical opening performance for coffee machines.

It should be noted that the design of double-blind grooves (4) can also be implemented on the inner surface of the edible product outlet cover member (23) of the capsule (1), since there are edible product dispensing systems and machines that use perforating members applied to the (edible product) outlet of the capsule. In this way, and for these specific cases, the problem of the difficulty of perforating the cellulosic material of the capsule is also solved.

Tests have demonstrated that the present invention also works fully on capsules made of plastic or aluminium materials, and in these cases the underlying problem of difficulty in perforation does not arise with the same urgency, at least with the thicknesses usually used in the current manufacturing process of plastic and aluminium capsules. However, it is anticipated that the application of the double grooves of the present invention may allow an overall reduction in the thicknesses adopted in the production process of plastic and aluminium capsules, which could constitute an improvement in terms of economics, resource management and ecological footprint.

In turn, the use of these more sustainable and fully compostable (cellulosic) ecological materials allows for a reduction in the negative impact that plastics and aluminium currently have on consumers and the environment.

The geometry and weight of the capsule (1) of the present invention are compatible with the operation of edible product filling lines.

The invention also relates to a process for producing the capsules (1) of cellulosic material of the present invention, wherein the process comprises a step of forming at least one double groove (4) on an inner surface (31) of the water inlet cover member (22) of the container (2) of the capsules to be produced.

### Tests

Tests were carried out with a multiplicity of depth ratios (411) and (421) and widths between the first groove (41) and the second groove (42). It was concluded that these ratios did not significantly affect the main aim of obtaining a successful perforation of the capsule (1) by the edible product machine, provided that the said grooves verified the double-blind groove configuration (4), as explained previously.

As to the tests made based on the simple weakening (a single groove or notch) of the capsule material to be perforated by the edible product machine, several defective perforations or even a lack of perforation by the machine were observed, thus generating a malfunction of the machine-capsule system.

### REFERENCE NUMERALS

1—Capsule made of cellulosic material;
2—container;
3—thickness of the water inlet cover member;
4—double-blind groove;
5—microfilm;
6—punching member of edible product machines;
7—inner surface of container;
21—side wall;
22—water inlet cover member;
23—edible product outlet cover member;
24—interior of container;
31—inner surface of water inlet cover member;
32—outer surface of water inlet cover member;
41—first groove;
42—second groove;
42′—single groove;
411—depth of the first groove;
421—depth of the second groove;

It should be noted that although the present invention has been described with reference to a plurality of embodiments, modifications may be made and other alternatives adopted by a person skilled in the art without departing from the scope of the invention, which is defined by the claims.

1. A capsule of cellulosic material for a soluble edible product, the capsule comprising a closed container, which contains a hollow interior containing an individual dose of a soluble edible product, and the container being delimited by a side wall, a water inlet cover member and an edible product outlet cover member, wherein the water inlet cover member comprises:
an inner surface facing an interior of the container,
an outer surface opposite to said inner surface and
a thickness defined by the distance between the inner surface and the outer surface
wherein
said water inlet cover member further comprises at least one double-blind groove arranged on the inner surface, wherein the double-blind groove comprises a first blind groove and a second blind groove; and
wherein
the second blind groove is contained in the first blind groove and
a depth of the first blind groove is lower than a depth of the second blind groove.

2. The capsule of cellulosic material according to claim 1, wherein the double-blind groove is arranged in a closed circumferential configuration on the inner surface of the water inlet cover member.

3. The capsule of cellulosic material according to claim 1, wherein the double-blind groove is arranged in an open circumferential configuration on the inner surface of the water inlet cover member.

4. The capsule of cellulosic material according to claim 1, wherein the capsule comprises two of the double-blind grooves configuring two semicircles, arranged in a same circumferential line on the inner surface of the water inlet cover member.

5. The capsule of cellulosic material according to claim 1, wherein the capsule comprises three of the double-blind grooves arranged in a same circumferential line on the inner surface of the water inlet cover member.

6. The capsule of cellulosic material according to claim 3 wherein the capsule further comprises one or more grooves arranged in a same circumferential line and connected to the second grooves of the double grooves.

7. The capsule of cellulosic material according to claim 1, wherein the double-blind groove is arranged in a central part of the inner surface of the water inlet cover member.

8. The capsule of cellulosic material according to claim 1, wherein the capsule comprises two of the double-blind grooves arranged, in cross configuration, in a central part of the inner surface of the water inlet cover member.

9. The capsule of cellulosic material, according to claim 1 wherein said side wall, said water inlet cover member and said edible product outlet cover member define an inner surface of the closed container, the inner surface of the closed container being partially or totally coated with a microfilm.

10. The capsule of cellulosic material, according to claim 9, wherein the microfilm is selected from the group consisting of poly(lactic acid) (PLA), polyhydroxybutyrate (PHB) and polyhydroxybutyrate-co-polyhydroxyhexanoate (PHBHx).

11. The capsule of cellulosic material, according to claim 1 wherein the cellulosic material is paper pulp.

12. The capsule of cellulosic material, according to claim 1 to the capsule further comprises at least one of the double-blind grooves arranged on an inner surface of the edible product outlet cover member.

13. A process for producing a capsule of cellulosic material as claimed in any claim 1 wherein the process comprises the step of forming at least one of the double grooves on the inner surface of the water inlet cover member (22) of the capsule.

14. A process for the preparation of espresso coffee, tea or other soluble edible products comprising the step of using the capsule of cellulosic material of claim 1.
